(19) United States
(12) Patent Application Publication
(10) Pub. No.: US 2026/0299318 A1
(43) Pub. Date: Oct. 1, 2026

(54) SPECTACLE LENS FOR MANAGING MYOPIA BY MEANS OF A DUAL PROGRESSION CONTROL PROCESS

(71) Applicant: Rodenstock GmbH, Muenchen (DE)

(72) Inventor: Matthias Rosensteiner, Ismaning (DE)

(21) Appl. No.: 19/477,687

(22) PCT Filed: Apr. 24, 2024
(86) PCT No.: PCT/EP2024/061229

§ 371 Date: Oct. 22, 2025

(30) Foreign Application Priority Data
Apr. 25, 2023 (DE) 102023110569.8

(51) Int. Cl. G02C 7/06; G02C 7/02

(52) U.S. Cl. CPC G02C 7/061; G02C 7/022; G02C 2202/24

(57) ABSTRACT

A spectacle lens, including: a central main viewing region with a substantially constant refractive power; and a functional region adjacent to the central main viewing region at least horizontally on both sides, the functional region having an additional functional effect compared to the central main viewing region, the additional functional effect including at least a dioptric addition power and/or a contrast reduction compared to the central main viewing region, wherein the additional functional effect in the functional region is achieved by a combination of at least one first surface structure characteristic and one second surface structure characteristic of the spectacle lens.

### TECHNICAL FIELD

The invention relates to a spectacle lens with a special distribution of optical addition powers to improve long-term wearing comfort while simultaneously improving perception.

### BACKGROUND

Myopia management is understood to mean the attempt to control abnormal growth of the eyeball's length, particularly in children and adolescents, which leads to severe myopia and is caused inter alia by a lifestyle dictated by modern society (little time outdoors and plenty of nearwork). One possible approach to controlling the progression of myopia is wearing special spectacle lenses that attempt to move the focal plane of the visual field in the periphery in front of the retina and thus slow the growth of the eyeball's length.

One possibility is spectacle lenses with a design similar to progressive lenses, which in the periphery, by an addition in power, bring the focal plane in the peripheral visual field in front of the retina. (e.g. U.S. Pat. No. 7,025,460, EP 1 934 648 B1, WO 2017/222421 A1, DE 10 2009 053 467 B4). Other spectacle lens variants have a multitude of small additional optical elements (lenslets, etc.) distributed across the spectacle lens and creating a second focal plane in front of the retina (e.g. CN 104678572 B, U.S. Pat. No. 10,268,050 B2, WO 2019/166653 A1, U.S. Pat. No. 8,950,860 B2, US 10901237 B2, US 11061255 B2). Another possibility is the insertion of small scatterers that reduce contrast in the periphery and thus inhibit the progression of myopia (e.g. WO 2018/026697 A1).

All of these spectacle lenses have in common that they have a central region that provides good vision due to a prescription of a corresponding corrective power, as well as a peripheral zone that does not provide good vision due to myopia management measures (lenslets, power increase, or scatterers). The size of the central zone is crucial for the tolerability of the spectacles, the size and power of the peripheral power zone are crucial for the success of myopia management. The ratio of the two zones is usually determined by the lens design and is the same for all corrective powers. Suggestions for adapting the zones to the individual eye are described e.g. in EP 3 966 626 A1. They are based on additional measurements, either as peripheral refraction or using a psychophysical method.

To date, various optical powers regarding the tolerability and comfort of ophthalmic lenses, in particular spectacle lenses, have been examined with regard to their influence on myopia and/or hyperopia, as well as their progression or development depending on the optical and physiological mechanisms that are intended to explain or slow down progression or advancement, in particular deterioration. Existing approaches are substantially based on imaging the image in front of the retina, as this is intended to slow the growth of the eyeball's length. It has been shown that it is sufficient (or even better) if this occurs only in the periphery of the retina.

In particular in spectacle lenses for correcting myopia, the often noticeable tendency for myopia progression leads to a decrease in the wearing comfort of once fitted spectacle lenses, and thus also the wearer's satisfaction and the tolerability of the spectacles, after a short period of time.

### SUMMARY

It is an object of the present invention to improve lasting tolerability of spectacles or spectacle lenses and thus achieve long-term wearing comfort in a cost-effective manner. According to the invention, this object is achieved by the subject matter of the independent claims. Preferred embodiments are the subject of the dependent claims.

Thus, in one aspect, the invention relates in particular to a spectacle lens comprising a central main viewing region with a substantially constant refractive power and preferably a substantially constant image contrast, and a functional region preferably adjacent to the central main viewing region at least horizontally on both sides, which functional region has an additional functional effect compared to the central main viewing region, comprising at least a dioptric addition power and/or a contrast reduction compared to the central main viewing region, wherein the additional functional effect in the functional region is achieved by a combination of at least one first surface structure characteristic and one second surface structure characteristic (different from the first surface structure characteristic) of the spectacle lens.

It is precisely by combining different functional effects by different structural characteristics of the spectacle lens for myopia management that a high degree of effectiveness in reducing myopia progression can be achieved, while still keeping undesirable side effects of the individual measures comparatively low. Such undesirable side effects of conventional spectacle lenses for myopia management are well known and are always kept within acceptable limits by striving to strike a balance between effectiveness and tolerability. This is achieved in particular by a suitable distribution and characteristic of the respective effect.

However, by the inventive combination of different effects, this compromise can be made significantly more in favor of a myopia-stopping effect without significantly increasing the individual undesirable side effects. It is well known that spectacle lenses similar to a progressive lens with a peripheral power increase (i.e. a peripheral dioptric addition power) impair vision in the periphery due to this addition power and exhibit the other typical disadvantages of a progressive lens (e.g. astigmatism in the lens, distortion, swaying effects). Spectacle lenses with microlenses (lenslets) restrict vision in particular by reduced contrast and secondary images. By the inventive combination of such different mechanisms of action, they can reinforce or complement each other in their effectiveness for myopia management, while the individual undesirable side effects can each be kept relatively low. It has been shown, in particular, that it is advantageous for the tolerability of a spectacle lens to keep such undesirable side effects to a minimum, even if several different side effects occur simultaneously. Conversely, the invention thus offers the possibility of increasing the effectiveness of spectacle lenses for myopia management compared to conventional lenses, while simultaneously maintaining tolerability.

The first and/or second surface structure characteristic(s) is understood to mean, in particular, a surface shape or surface power that deviates from a pure or simple spherical shape or power, preferably also from an astigmatic surface shape or power. In one aspect, the optical power of the first and/or second surface structure characteristic deviates from a surface for pure vision correction.

Preferably, the first and/or second surface structure characteristic(s) comprise(s):
a progressive surface refractive power; and/or
a microlens arrangement (microlens field); and/or
a contrast reduction.

The progressive surface refractive power is achieved in particular by a continuous freeform surface of the spectacle lens, wherein the surface curvature of the front and/or back surface(s) of the spectacle lens is continuously varied from the central main viewing region to the functional region or within the functional region in such a way that the functional region at least partially produces a higher refractive power than the substantially constant refractive power in the central main viewing region, so that the portion of the light passing through this functional region is imaged in front of the retina to counteract the growth of the eyeball's length. In other words, the progressive surface refractive power of the first and/or second surface structure characteristic(s) preferably at least partially produces a positive dioptric addition power, i.e. the surface refractive power in the functional region is then preferably at least partially less negative or more positive than in the central main viewing region.

In particular, the first and/or second surface structure characteristic(s) is/are formed as microstructures, in particular as microlenses (in particular nubs of the spectacle lens body, also called lenslets), so that the portion of the light passing through these microlenses (lenslets) is imaged in front of the retina to counteract the growth of the eyeball's length. For this purpose, the lenslets preferably have a positive dioptric addition power. Such lenslets can be both classic circular lenslets (e.g. CN 104678572 B), as well as astigmatic (WO 2019/166653 A1) or even annular structures (WO 2021/047488 A1), in particular anything that has a discontinuity between the basic power and the (small) structural elements and produces a corresponding addition power.

As a further possibility for the first and/or second surface structure characteristic(s), spectacle lenses with scatterers (e.g. WO 2019/152428 A1) could preferably be used to achieve a contrast reduction. A contrast reduction is achieved in particular by a diffuser structure (light scatterer) as the first and/or second surface structure characteristic(s). In one aspect, microstructures in the functional region at least partially achieve the contrast reduction. For this purpose, the microstructures preferably comprise surface roughnesses that cause a dullness of the optical image. This dullness then leads to a contrast reduction. Here, the central main viewing region preferably remains substantially clear, while the contrast reduction is only created in the functional region. This contrast reduction contributes to the corresponding (peripheral) field of vision providing little or no incentive for the growth of the eyeball's length. This contrast reduction is in particular effective if the resulting perception (or degree of perception) in the region of the contrast reduction is in the range of at least about 0.5, preferably in the range of at least about 0.7. Preferably, the perception due to the contrast reduction is not greater than about 0.9, even more preferably not greater than about 0.8.

Perception should be understood here in particular as the factor by which the visus (i.e., visual acuity) is reduced, wherein a visual acuity determined to be a value of 1 according to DIN 58220 Part 3 is assumed as a reference. Thus, a perception of 0 (<0.1) means substantially complete occlusion, and 1, in principle, complete transparency. These properties arise in particular when the spectacle lens is arranged in a position with a typical corneal vertex distance (CVD), i.e. in particular when at least one CVD value is in the range of about 11 mm to about 18 mm, in particular preferably when at least one CVD value is about 13 mm or about 14 mm. Alternatively or in addition to complying with the value ranges for perception proposed here, it may be in particular preferred if the contrast reduction caused by the microstructure in the effect region results in a haze value (in particular % haze) according to the ASTM D-1003 standard in the range of no more than about 10, preferably in the range of no more than about 2, and preferably the contrast reduction caused by the microstructure in the effect region results in a haze value according to the ASTM D- 1003 standard in the range of at least about 0.1, in particular at least about 0.5.

Particularly preferably, in the case of a contrast reduction, the effect region still has a transmission (in particular a luminous transmittance value according to the ASTM D-1003 standard) of at least 85, even more preferably at least 90. This ensures that even in the case of a contrast reduction, the spectacle lens does not completely block the light (e.g. absorbs and/or reflects it) and thus darken the field of vision, but that the light is only (partially) scattered. This largely preserves the impression of brightness and prevents the pupil from becoming noticeably enlarged (due to reduced light incidence).

The values for both haze and luminous transmittance according to the ASTM D-1003 standard can be determined or verified, for example, using the “haze-gard plus” measuring device from BYK Additives and Instruments.

All combinations of the approaches described or others are possible, although a combination of lenslets or scatterers with a freeform surface is in particular preferred, as the different optical deficits (discontinuities and non-coaxial regions on the one hand, and large-scale increase in power and distortion on the other) then each have a different effect on the visual perception.

Thus, in a in particular preferred embodiment, the first surface structure characteristic comprises microstructures, in particular in the form of microlenses (lenslets), that produce a first positive dioptric addition power compared to the central main viewing region, wherein the second surface structure characteristic comprises, in particular, a progressive surface refractive power that produces a second positive dioptric addition power compared to the central main viewing region.

In a further, in particular preferred embodiment, the first surface structure characteristic comprises optical scatterers that produce a contrast reduction compared to the central main viewing region, wherein the second surface structure characteristic comprises a progressive surface refractive power that produces a second positive dioptric addition power compared to the central main viewing region.

In particular, it would also be possible to combine three different surface structure characteristics and have them interact, or to combine several effects (e.g. microlenses and optical scatterers) as the first surface structure characteristic and have them interact.

An interaction of the first and second surface structure characteristics can occur in various ways. Depending on the embodiment, the different surface structure characteristics can at least partially split the functional region in terms of area in such a way that in some regions (i.e. for some viewing points), one surface structure characteristic predominantly or solely dominates or provides the functional effect for myopia control, while alternatively or in addition, in other regions, the other surface structure characteristic predominantly or solely dominates or provides the functional effect for myopia control. Alternatively or in addition, it is also possible for the first and second surface structure characteristics to jointly effect the functional effect at least in parts (i.e. for some viewing points) of the functional region.

In a particular preferred embodiment, the first surface structure characteristic is formed on the front surface of the spectacle lens, and the second surface structure characteristic is formed on the back surface of the spectacle lens. Such spectacle lenses can be manufactured particularly easily, and the first and second surface structure characteristics can interact efficiently without adversely affecting each other. The “front surface” and “back surface” of the spectacle lens are understood to mean, in particular, the front surface and back surface of a spectacle lens base body, respectively. It does not always have to correspond to one of the surfaces of the finished spectacle lens. Rather, it is also possible for the spectacle lens base body (e.g. after forming the front and/or back surface(s)) to be provided with one or more coatings. Such coatings can include, for example, protective coatings, cover layers, hard coatings, color coatings, anti-reflective coatings, anti-fog coatings, etc.

In a preferred embodiment, the functional region comprises at least one combined effect region such that, for each viewing point of the spectacle lens within the combined effect region, the functional effect is brought about by the combination of the first and the second surface structure characteristic. Alternatively or in addition, in a preferred embodiment, the functional region comprises at least one first and/or one second exclusive effect region(s) such that, for each viewing point of the spectacle lens within the first or second exclusive effect region, the functional effect is brought about solely by the first or the second surface structure characteristic. In other words, it is preferred in one embodiment, for example, if in a first exclusive effect region the second surface structure characteristic is not active or is not present and/or if in a second exclusive effect region the first surface structure characteristic is not effective or is not present.

This allows the undesirable side effects that are in particular critical (i.e. less tolerable) for certain regions of use (i.e. fields of vision) of the spectacle lens to be selectively suppressed very efficiently without impairing the functional effect for myopia control. Thus, in a preferred embodiment in particular, the central main viewing region is completely surrounded by a first exclusive effect region, which is followed by a combined effect region. The first surface structure characteristic in particular preferably comprises microlenses, while the second surface structure characteristic in particular comprises a progressive surface refractive power.

For example, it can be particularly advantageous to initially use only (or predominantly) microstructures (e.g. microlenses/lenslets) directly adjacent to the main viewing region to produce the functional effect (in particular in the form of a positive dioptric addition power), and to supplement or (partially) replace their effect toward the periphery of the spectacle lens by increasing a progressive surface refractive power (positive dioptric addition power). This enables an effective and highly efficient functional effect for myopia management even near the central main viewing region, while the slower increase in surface refractive power allows astigmatic side effects to be kept to a minimum. At the same time, the formation of secondary images is minimized or suppressed, particularly in the peripheral region.

In a preferred embodiment, the spectacle lens comprises:
a continuous channel region extending continuously from an upper edge to a lower edge of the spectacle lens and encompassing the central main viewing region; and
a combined effect region horizontally adjacent to the continuous channel region on both sides and extending continuously from the upper to the lower edge of the spectacle lens,
wherein a dioptric addition power of the spectacle lens caused by the second surface structure characteristic increases away from the channel region on both sides of the channel region.

It is particularly preferred in this embodiment if the channel region comprises a first upper and a first lower exclusive effect region, in which the addition power is created substantially by the first surface structure characteristic, which particularly comprises microlenses, while the second surface structure characteristic comprises a progressive surface refractive power (with a positive dioptric addition power).

Compared to spectacle lenses having their central zones completely surrounded by a plus power due to a progressive surface refractive power, this variant with only lateral progression of the surface refractive power improves tolerability due to the significant reduction in distortion in all directions achieved thereby, although the functional effect of the first surface structure characteristic (e.g. in the form of microlenses) is very efficiently realized in all directions, thus also providing very effective myopia control. This achieves a high level of tolerability while simultaneously suppressing myopia progression.

The directions “upward” and “downward” (and derived terms such as “below” and “above”), as well as terms for the directions “nasal”, “temporal”, “horizontal”, and “vertical” in this description are always used in relation to the wearing position of the spectacle lens, which is determined in particular by the centration data for the spectacle lens. Here, the “lower” and “upper” edges of the spectacle lens are preferably understood to mean an edge portion of a lower and upper half, respectively, more preferably a lower or upper third, even more preferably a lower or upper quarter, of a spectacle lens surface (front surface and/or back surface) of the spectacle lens. Particular preferably, an upper or lower edge refers particularly to a portion of the edge of the entire spectacle lens that delimits the uppermost or lowermost 20%, preferably 15%, even more preferably 10%, and most preferably 5%, of the vertical height of the spectacle lens. The spectacle lens referred to in this description can particularly be an already cut or fitted (finished) spectacle lens or an uncut spectacle lens.

In a further aspect, the invention relates to a method for producing a spectacle lens, in particular one of the spectacle lenses described here, wherein the method comprises producing the first surface structure characteristic on a front surface of the spectacle lens and producing the second surface structure characteristic on a back surface of the spectacle lens. This is in particular preferred if the first surface structure characteristic is created during casting of a spectacle lens semi-finished product and, in particular, comprises microlenses. Alternatively or in addition, it is in particular advantageous if the second surface structure characteristic is created by grinding the back surface and, in particular, comprises a progressive surface refractive power.

Finally, the invention relates to a use of one of the spectacle lenses described here for compensating for a myopic vision defect and/or for reducing the progression of myopia.

### BRIEF DESCRIPTION OF THE DRAWINGS

The invention will be further described below using preferred embodiments with reference to the accompanying drawings, which show:

FIG. 1 illustrates a schematic representation of individual regions on a spectacle lens according to a preferred embodiment;

FIG. 2a illustrates a schematic representation of an exemplary refractive power distribution as a second surface structure characteristic in a spectacle lens according to a preferred embodiment;

FIG. 3a illustrates a schematic cross-sectional view of a spectacle lens front surface for illustrating microlenses as an example of a first surface structure characteristic in a spectacle lens according to a preferred embodiment; and

FIG. 4a illustrates a schematic representation of an exemplary distribution of microlenses as a first surface structure characteristic in a spectacle lens according to a preferred embodiment.

### DETAILED DESCRIPTION

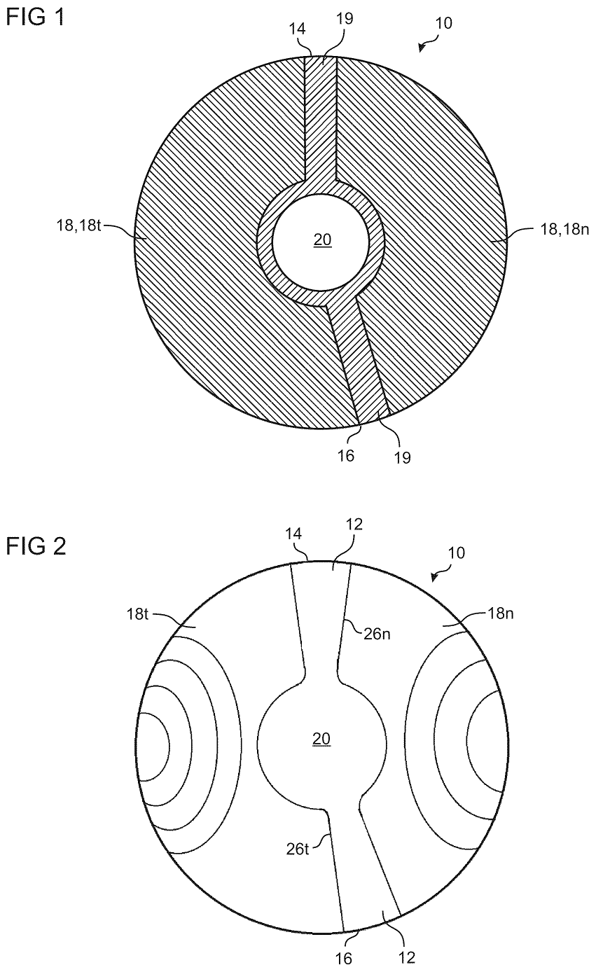

A preferred embodiment of a spectacle lens for myopia control with dual progression control combines the “lenslets” and “peripheral power increase” approaches, with the “lenslets” approach being located on the front surface of the spectacle lens and the “peripheral power increase” approach being located on the back surface of the spectacle lens. Exemplary implementations of this preferred embodiment will be described below with reference to FIGS. 1 to 4:

FIG. 1 shows a schematic distribution of individual regions on a spectacle lens 10 according to a preferred embodiment. In particular, the spectacle lens 10 comprises a central main viewing region 20 with a substantially constant refractive power. In this embodiment, the central main viewing region 20 is surrounded by a functional region, which in this case comprises an exclusive effect region 19 and a combined effect region 18. Compared to the central main viewing region 20, the functional region 18, 19 has an additional functional effect, which in the preferred embodiment illustrated here comprises at least one dioptric addition power compared to the central main viewing region 20. The additional functional effect in the functional region 18, 19 is achieved by a combination of a first surface structure characteristic and a second surface structure characteristic of the spectacle lens 10.

In the embodiment illustrated here, the first surface structure characteristic is formed particularly by microlenses, which provide at least part of the dioptric addition power compared to the central main viewing region 20. The second surface structure characteristic is formed particularly by a progressive surface refractive power, which in turn also provides at least part of the dioptric addition power compared to the central main viewing region 20. Particularly preferably, in this embodiment, the first surface structure characteristic is formed on the front surface and the second surface structure characteristic is formed on the back surface of the spectacle lens 10.

Particularly in the exclusive effect region 19, the functional effect is created substantially only by the first surface structure characteristic, while in the combined effect region 18, the functional effect is created by both surface structure characteristics together (i.e. in sum). In other words, within the exclusive effect region 19, there is preferably substantially no progressive surface refractive power contributing to the positive dioptric addition power of the functional effect. In particular, in the exclusive effect region 19, a progressive surface refractive power contributes no more than about 20%, preferably no more than about 10%, most preferably no more than about 5%, to the positive dioptric addition power. Preferably, within the combined effect region 18, each of the two surface structure characteristics contributes at least about 10%, even more preferably at least about 20%, most preferably at least about 25%, to the positive dioptric addition power.

While the exclusive effect region 19 in this preferred embodiment completely surrounds the central main viewing region 20, the combined effect region 18 adjoins the exclusive effect region 19 laterally on both sides. In this way, in the exemplary embodiment shown, the exclusive effect region 19 and the central main viewing region 20 together form a continuous channel region. This channel region is thus a region that, in this embodiment, is substantially free of the second surface structure characteristic. In FIG. 2, which will be described below, this channel region is represented by the reference numeral 12.

Here, the channel region 12 extends continuously from an upper edge 14 of the spectacle lens 10 to a lower edge 16 of the spectacle lens 10. This channel region 12 is surrounded nasally and temporally by a respective nasal effect portion 18n and a temporal effect portion 18t of the combined effect region 18, which in particular directly border the channel region 12 along a respective nasal channel boundary line 26n and a temporal channel boundary line 26t (FIG. 2). FIG. 2 shows a schematic representation of an exemplary variation in the refractive power distribution due to the second surface structure characteristic, implemented in particular on the back surface, in the form of a progressive surface refractive power in a spectacle lens 10 according to a preferred embodiment. This schematic representation could fundamentally correspond in particular to a spectacle lens 10 of FIG. 1. Thus, the channel region 12 extends from the upper edge 14 of the spectacle lens 10 to the lower edge 16 of the spectacle lens. The nasal effect portion 18n and the temporal effect portion 18t adjoin this channel region 12 on the sides.

The lines shown in FIG. 2 in addition to the entire edge profile of the spectacle lens represent lines (isolines) of the same refractive power on the back surface of the spectacle lens 10. For example, the refractive power distances between adjacent lines in FIG. 2 could each indicate a difference of 0.5 dpt. As can be seen from this, the entire channel region 12 lies in a region with substantially constant refractive power. For the entire spectacle lens 10, this means that either the total refractive power of the spectacle lens is substantially constant (as is in particular the case in the central main viewing region 20) or the functional effect is determined by the first surface structure characteristic (as is the case in the exclusive effect region 19).

Regardless of the absolute value of the refractive power, the spectacle lens 10 preferably has the lowest refractive power in the channel region 12 in the illustration in FIG. 2. Toward the lateral effect portions 18n, 18t, the surface refractive power then increases steadily due to the second surface structure characteristic and, in the schematic illustration, reaches its respective maximum at about mid-height in the region of the lateral edges of the spectacle lens 10.

The back surface is designed, in particular, using freeform technology. In this case, the spectacle lens 10 receives the power necessary to correct distance vision in the channel region 12, in particular in the central main viewing region 20. In the lateral peripheral zones, in particular in the combined effect zone 18, an increase in power is incorporated, so that the spectacle lens, due to the second surface structure characteristic, receives for example an addition power of 2.5 dpt (second positive dioptric addition power) temporally at about 25 mm from a center point of the central main viewing region 20, and an addition power of 2.0 dpt (second positive dioptric addition power) nasally at about 25 mm from the center point of the central main viewing region 20. In the vertical direction, the channel region extends substantially without any addition power by the second surface structure characteristic, while a moderate increase in power is observed at the top and bottom sides.

It is in particular preferred that the maximum surface refractive power of the back surface of the spectacle lens in the nasal and temporal effect portions differ from each other by no more than about 3 dpt, preferably no more than about 2 dpt, even more preferably no more than about 1 dpt, and most preferably no more than about 0.5 dpt. Alternatively or simultaneously, depending on the embodiment and field of application, the maximum surface refractive power of the back surface of the spectacle lens in both the nasal and temporal effect regions is at least about 1 dpt, preferably at least about 1.5 dpt, more preferably at least about 2 dpt, even more preferably at least about 2.5 dpt, and most preferably at least about 3 dpt greater than the minimum surface refractive power of the back surface of the spectacle lens in the channel region 12.

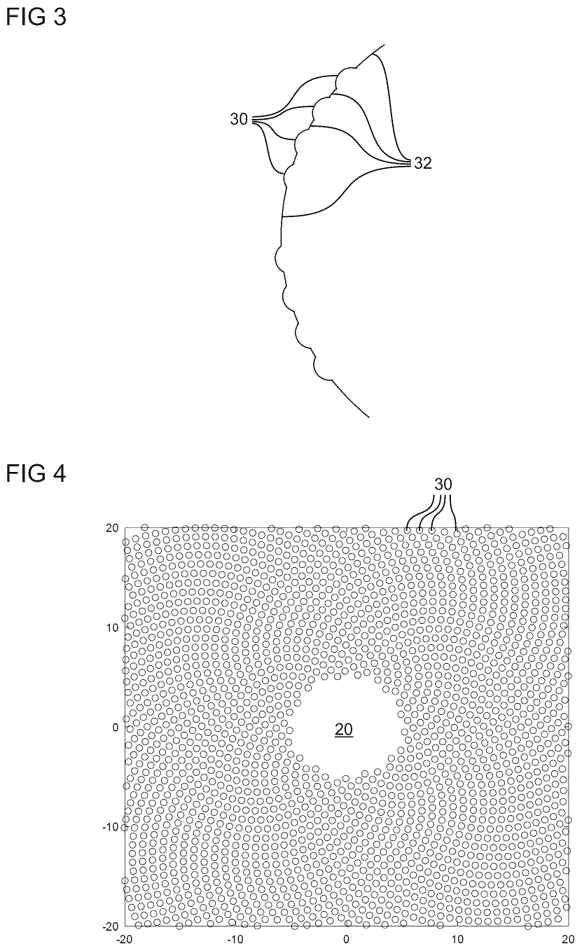

In a preferred embodiment, the first surface structure characteristic is realized in particular by microstructures on the spectacle lens front surface. As shown by way of example in FIG. 3, the microstructures are designed in particular as microlenses 30 (in particular nubs on the spectacle lens body) to image the portion of the light passing through these microlenses (lenslets) in front of the retina in order to counteract the growth of the eyeball's length. For this purpose, the lenslets 30 preferably have a positive dioptric addition power (first positive dioptric addition power). For example, an addition power of about 3.5 dpt has proven effective. Other powers (e.g. 2 to 5 dpt) are equally possible and should produce a similar effect. The optical power of the nubs is created by refraction at the interface between the spectacle lens body and the environment (e.g. air or a protective layer in the region of the nubs).

The “lenslets” approach refers in particular to small, in particular circular regions on the spectacle lens front surface 32, which differ in power from the region around these elements, the so-called basic power. This power is achieved by a modified curvature of the front surface in this region. The lenslets have, for example, a diameter of about 1 mm and a power that differs from the basic power by about 3.5 dpt (first positive dioptric addition power). They are in particular preferably arranged around the central main viewing region 20 according to the Fibonacci sphere distribution (see FIG. 4), the central main viewing region 20, with a preferred diameter in the range of about 5 mm to about 20 mm, preferably in a range of about 10 mm to about 15 mm, preferably remaining free of lenslets for good central vision. The lenslets are preferably already included in the molds of the semi-finished spectacle lens products.

In summary, one idea of the present invention is to combine two approaches for myopia management spectacle lenses. The myopia management spectacle lens with such dual progression control thus incorporates two designs for myopia control and, for example, has a multitude of additional power elements (microlenses or lenslets) on the front surface and a back surface that provides an additional power in the periphery (e.g. as a progressive surface refractive power).

The different concepts of the spectacle lenses for myopia control have different optical disadvantages. By combining the designs, different optical defects are combined, preventing a dominant error from occurring that excessively impairs tolerability. This allows more power in front of the retina. The invention thus achieves greater effectiveness for myopia control by providing more power in front of the retina while simultaneously improving tolerability by an adapted distribution of the optical defects.

### LIST OF REFERENCE NUMERALS

10 lens
12 channel region
14 upper edge
16 lower edge
18n nasal effect portion
18t temporal effect portion
20 central main viewing region
26n nasal channel boundary line
26t temporal channel boundary line
30 microlenses (lenslets)
32 spectacle lens front surface

1-14. (canceled)

15. A spectacle lens, comprising:
a central main viewing region with a substantially constant refractive power; and
a functional region adjacent to the central main viewing region at least horizontally on both sides, the functional region having an additional functional effect compared to the central main viewing region, the additional functional effect including at least a dioptric addition power and/or a contrast reduction compared to the central main viewing region,
wherein the additional functional effect in the functional region is achieved by a combination of at least one first surface structure characteristic and one second surface structure characteristic of the spectacle lens:
at least one combined effect region within the functional region such that. for each viewing point of the spectacle lens within the combined effect region, the functional effect is brought about by the combination of the first and the second surface structure characteristic; and
a continuous channel region extending continuously from an upper edge to a lower edge of the spectacle lens and encompassing the central main viewing region,
wherein the combined effect region is horizontally adjacent to the continuous channel region on both sides and extends continuously from an upper to a lower edge of the spectacle lens,
wherein a dioptric addition power of the spectacle lens caused by the second surface structure characteristic increases away from the channel region on both sides of the channel region, and
wherein the channel region comprises a first upper and a first lower exclusive effect region, in which the addition power is created substantially by the first surface structure characteristic.

16. The spectacle lens according to claim 15, wherein the first and/or second surface structure characteristics comprise a progressive surface refractive power, and/or a microlens arrangement, and/or a contrast reduction.

17. The spectacle lens according to claim 15,
wherein the first surface structure characteristic comprises microlenses that produce a first positive dioptric addition power compared to the central main viewing region, and
wherein the second surface structure characteristic comprises a progressive surface refractive power that produces a second positive dioptric addition power compared to the central main viewing region.

18. The spectacle lens according to claim 15,
wherein the first surface structure characteristic comprises optical scatterers that produce a contrast reduction compared to the central main viewing region, and
wherein the second surface structure characteristic comprises a progressive surface refractive power that produces a second positive dioptric addition power compared to the central main viewing region.

19. The spectacle lens according to claim 15, wherein the first surface structure characteristic is formed on a front surface of the spectacle lens, and the second surface structure characteristic is formed on a back surface of the spectacle lens.

20. (canceled)

21. The spectacle lens according to claim 15, wherein the functional region comprises at least one first and/or one second exclusive effect region such that, for each viewing point of the spectacle lens within the first or second exclusive effect region, the functional effect is brought about solely by the first or the second surface structure characteristic.

22. The spectacle lens according to claim 21, wherein the central main viewing region is completely surrounded by a first exclusive effect region, which is followed by a combined effect region.

23. (canceled)

24. (canceled)

25. A method for producing a spectacle lens according to claim 15, comprising:
producing the first surface structure characteristic on a front surface of the spectacle lens, and
producing the second surface structure characteristic on a back surface of the spectacle lens.

26. The method according to claim 25, wherein the first surface structure characteristic is created during casting of a spectacle lens semi-finished product.

27. The method according to claim 25, wherein the second surface structure characteristic is created by grinding the back surface.
